(19) United States
(12) Patent Application Publication
(10) Pub. No.: US 2004/0083388 A1
(43) Pub. Date: Apr. 29, 2004

(54) Method and apparatus for monitoring data packets in a packet-switched network

(76) Inventor: The Vinh Nguyen, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/350,055

(22) Filed: Jan. 24, 2003

Related U.S. Application Data
(60) Provisional application No. 60/421,091, filed on Oct. 25, 2002.

(51) Int. Cl. G06F 11/30; G06F 15/173

(52) U.S. Cl. 713/201; 709/223

(57) ABSTRACT

A method and apparatus is disclosed for monitoring data. The monitoring apparatus comprises an incoming control unit, an outgoing control unit, a database building unit, a fraudulent address table, an application type table and a legitimate address table and an alarm and report system.

### CROSS-REFERENCE TO RELATED APPLICATIONS

This application claims priority of the U.S. provisional patent application bearing application No. 60/421,091, filed Oct. 25, 2002, the specification of which is incorporated by reference.

### TECHNICAL FIELD

This invention relates to the field of computer security. More precisely, this invention pertains to the field of firewalls.

### BACKGROUND OF THE INVENTION

With advances of information technology, many home computers are connected to the Internet, which creates vulnerability of their systems with respect to hackers.

A hacker can slip out data from a computer by using a self-started program or by flooding the computer with illegitimate data.

Some Internet providers have developed data filtering method and apparatus in order to try to avoid hacking attempts, but unfortunately, they are very complex to set up and maintain. Furthermore, if the Internet provider provides the Internet access to a large amount of users, it may be difficult to provide a filtering policy that will suit the needs of each of the large amount of users.

At their end, home users are usually not experts in networking security. It will be appreciated that frequent knowledge updates are mandatory with networking security. Such knowledge updates are too time-consuming for a simple user. While various products may be available on the market in order to avoid hacker intrusion, most of them are too complex to be operated by a home user of normal skills.

Furthermore, it will be appreciated by someone skilled in the art that the introduction of high-speed Internet access causes a home system to be usually permanently connected to the Internet. Such permanent connection may cause the computer to be highly vulnerable for intrusion or illegitimate access, especially as the user is not always physically present near the computer.

In view of the above, there is a need for a method and apparatus that will overcome the above-identified drawbacks.

### SUMMARY OF THE INVENTION

It is an object of the invention to provide a monitoring system which is easy to set-up, to operate, and to maintain.

It is another object of the invention to provide a monitoring system for a packet-switched network that will implement a filtering policy depending on various criteria dedicated for monitoring at least one network computer (host).

Yet another object of the invention is to provide a method for monitoring a plurality of data packets shared between a plurality of network hosts located in a first packet switched network and another host located in a second packet switched network.

It is another object of the invention to provide a method for monitoring a plurality of data packets shared between a first network host a second network host located in a packet switched network.

In accordance with a first aspect of the invention, there is provided a method for filtering a data packet shared between a first network host and a second network host connected using a packet-switched network connection, comprising receiving a data packet originating from a network application running on a first network host, the data packet comprising at least a network application type identifier and an address on said packet-switched network, performing a first check to find out if said address is acceptable using a fraudulent address table database and a legitimate address table database, performing a second check using at least said network application type identifier and an application type table database comprising at least a list of a plurality of allowed network applications and providing said data packet to a second network host if said first check and said second check are successful.

In accordance with another aspect of the invention, there is provided an apparatus for filtering a data packet shared between a first network host and a second network host connected using a packet-switched network, comprising a fraudulent address table database, comprising a plurality of illegitimate addresses, an application type table database comprising at least a list of allowed network applications, a legitimate address table database comprising at least a list of allowed addresses, a control unit intercepting a data packet originating from a network application running on a first network host and providing at least a network application type identifier and an address and further providing said data packet to a second network host upon reception of a positive decision signal and a database building unit receiving at least said network application type identifier and said address, checking at least said provided network application type identifier and said address using said fraudulent address table database, said application type table database and said legitimate address table database, and providing said positive decision signal to said control unit if said checking is successful.

In accordance with another aspect of the invention, there is provided a method for monitoring a data packet shared between a first network host and a second network host connected using a packet-switched network connection, comprising receiving a data packet originating from a network application running on a first network host, the data packet comprising at least a network application type identifier and an address on said packet-switched network, performing a first check to find out if said address for a second network host is acceptable using a fraudulent address table database and a legitimate address table database, performing a second check using at least said network application type identifier and an application type table database comprising at least a list of a plurality of allowed network applications, providing a report, comprising at least one part of said data packet, to a user if said first check and said second check are not successful and providing said data packet to said second network host.

### BRIEF DESCRIPTION OF THE DRAWINGS

Further features and advantages of the present invention will become apparent from the following detailed description, taken in combination with the appended drawings, in which:

FIG. 1 is a diagram which shows various embodiments for connecting a host to a wide area packet-switched network such as the Internet;

FIG. 2 is a block diagram which shows the preferred embodiment of the invention; in this embodiment the system comprises a database building unit, an outgoing control unit, an incoming control unit, a database building unit, a fraudulent address table database, an application type table, an legitimate address table database and an alarm and report system;

FIG. 3 is a table which shows an example of a fraudulent address table (FAT) database;

FIG. 4 is a table which shows an example of a legitimate address table (LAT) database;

FIG. 5 is a table which shows an example of an application type table (ATT) database;

FIG. 6 is a block diagram which shows a first configuration; in this first configuration an incoming data packet is received by the incoming control unit;

FIG. 7 is a block diagram which shows a second configuration; in the second configuration, an outgoing data packet is received by the outgoing control unit and validated;

FIG. 8 is a flow chart which shows how the preferred embodiment of the invention operates; a first check is the fraudulent address table is performed, then a second check in the application type table is performed then a check in the legitimate type table is performed if required;

FIG. 9 is a flow chart which shows how unattended mode operates; a first check in the fraudulent address table is performed then a check is performed in order to find out if unattended mode is allowable;

FIG. 10 is a screenshot of a graphics user interface of the application type table database;

FIG. 11 is a graphics user interface of the application type table database in which a user is able to select, for an application, a field “originating”, a field “terminating” and a field “check LAT”;

FIG. 12 is a graphics user interface of the application type table database in which a user is able to select, for an application, a field “temporary access”, a field “originating reply”, a field “supervision timer” and a field “terminating reply”;

FIG. 13 is a graphics user interface of the application type table database in which a user is able to select, for an application, a field “incoming access”, a field “permanent access”, a field “outgoing access” and a field “temporary access”;

FIG. 14 is a graphics user interface of the legitimate address table database in which a user is able to select, for an application, a field “IP type”, a field “IP address” and a field “IP access type”; and

FIG. 15 is a graphics user interface of the fraudulent address table database in which a user is able to select, for an application, a field “barred IP address”.

It will be noted that throughout the appended drawings, like features are identified by like reference numerals.

### DETAILED DESCRIPTION OF THE PREFERRED EMBODIMENT

While the above description will provide an understanding of the invention in the case of a TCP/IP network, it will be appreciated that this invention may be adapted to operate with any packet-switched network communication protocol.

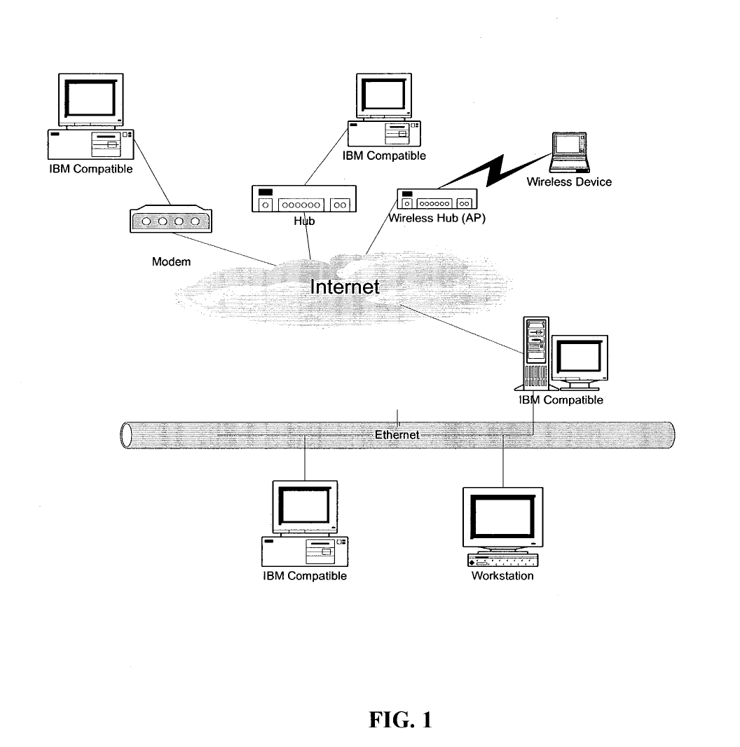

Now referring to FIG. 1, there is shown how a user connects a computer to a packet-switched Wide Area Network (WAN) such as the Internet. The user connects the computer to the Internet using either a Modem, or using a connection to a HUB which is connected itself to the Internet, or via a Local Area Network (LAN), or using a Wireless Network.

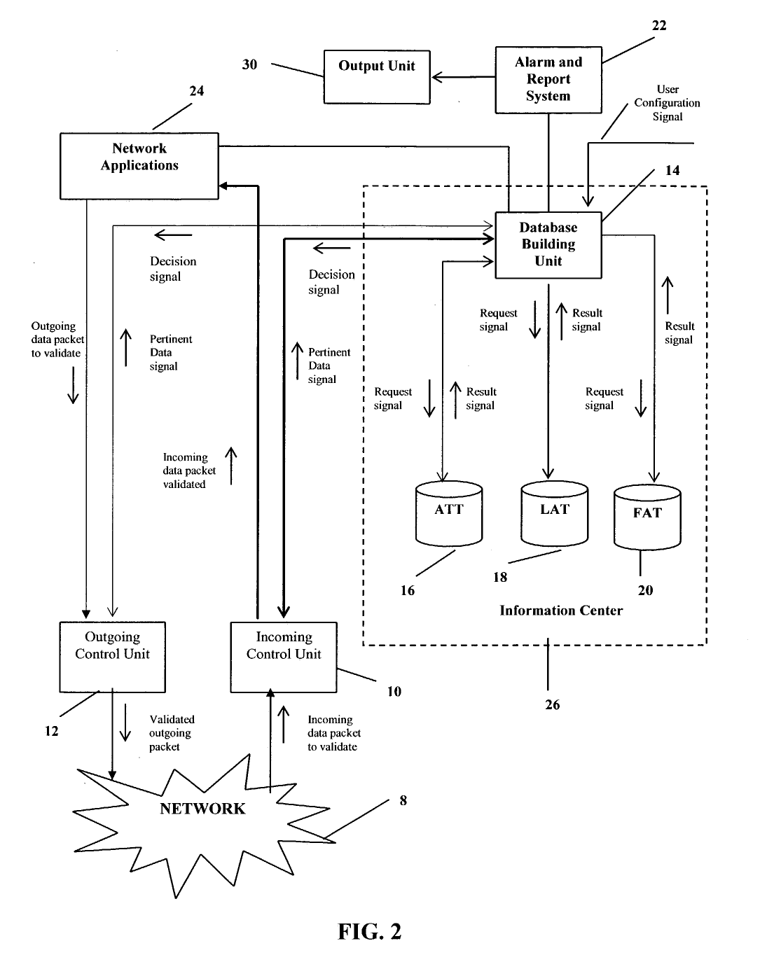

Now referring to FIG. 2, there is shown the preferred embodiment of the invention.

In this preferred embodiment, the system comprises an incoming control unit 10, an outgoing control unit 12, a database building unit 14, an application type table (ATT) database 16, a legitimate address table (LAT) database 18, a fraudulent access table (FAT) database 20, an alarm and report system unit 22, an output unit 30, and a plurality of network applications 24.

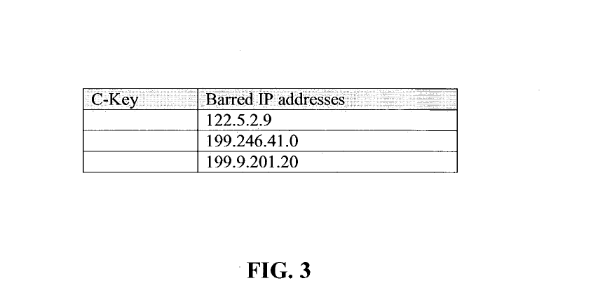

Now referring to FIG. 3, there is shown an example of the fraudulent address table database 20.

The fraudulent activity table database 20 comprises barred addresses. The barred addresses are either manually created, e.g. during system setup, or automatically inserted when a suspect activity is detected by the monitoring system. It will be appreciated that the fraudulent activity table database 20 may comprise an entire subnet.

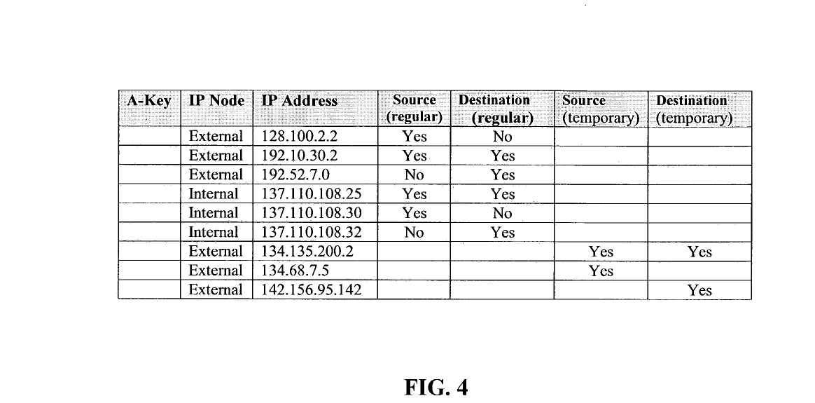

Now referring to FIG. 4, there is shown an example of the legitimate address table database 18.

The legitimate address table database 18 comprises an entry for authorized external nodes address, e.g. a legitimate destination address or a source address. An external node is either a source of a message sent to an internal application, or a destination node of a message received from a network application 24.

The legitimate address table database 18 also comprises an entry for authorized internal nodes in the case where the invention is used with a plurality of computers.

In the preferred embodiment of the invention, there are two types of legitimate addresses, i.e. regular, permanent, legitimate addresses created by a user or a system administrator, and temporary legitimate addresses created by an application during an access as explained below.

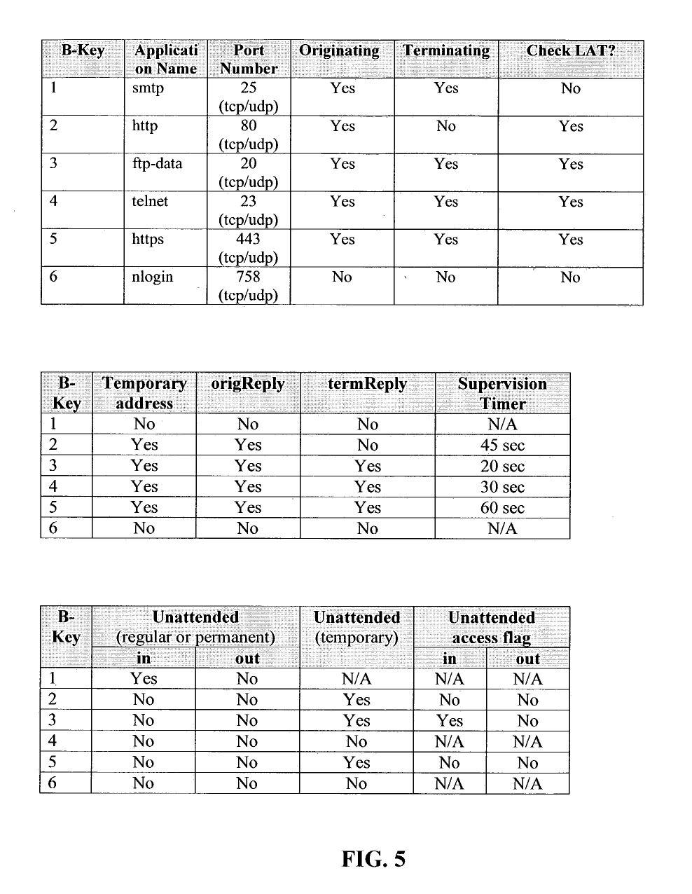

Now referring to FIG. 5, there is shown a table which shows an example of the application type table database 16 in the preferred embodiment of the invention.

The application type table database 16 provides a validation method required for a given network application 24 connecting to the network 8.

For example, the Internet application is eligible of receiving and whether the temporary address is required to be inserted or removed from the legitimate address table database 18.

In the preferred embodiment of the invention, the application type table database 16 comprises, for each type of network application of a defined protocol, an originating field, a terminating field, a check LAT field, a temporary address field, an origReply field, a termReply field, a supervision field, an unattended field, an unattended temporary field, an unattended access flag field.

The originating field indicates if a network application 24 is eligible to originate sending a data packet to a host of the network 8.

The terminating field indicates if a network application 24 is eligible to receive a data packet, which had been originated by a host of the network 8.

The check LAT field indicates if an examined data packet is required to be validated using the legitimate address table database 18.

The temporary address field indicates if a temporary address will be created and removed for a network application 24.

The origReply field indicates if a monitored host is allowed to receive a replied data packet for a message, which had been originated by a network application 24.

The termReply field indicates if the monitored host is allowed to send a data packet in response to a message, which had been originated by a host of the network 8.

The supervision field, which is associated with the temporary address field, provides time supervision of a temporary address. As explained below, a temporary address will be removed upon completion of a network transaction of a network application 24 or by the database building unit 24 when the supervision timer elapsed.

The regular or permanent unattended field is used to specify permanent privilege of network access, when the monitored host is in unattended mode, for a network application 24.

The unattended temporary field reserves for an ongoing network application 24 to continue network access until completion, even though the user sets the monitored host to unattended mode.

The unattended access flag field is used in order to define if a network application 24 is allowed to share a data packet when the user is physically away from the computer running the network application 24.

As shown in FIG. 5, many network applications of the TCP/IP protocol are defined such as SMTP, HTTP, FTP-DATA, TELNET, HTTPS, NLOGIN, etc.

For instance, Internet Web browser is a network application program type (HTTP) which is allowed to use a temporary address and to remove it at the end of each replied message as explained below.

This network application program type is both an originating Internet application type, in the case of a web client, and a terminating Internet application type, in the case of a web server.

For instance, a Peer-to-Peer (p2p) program is one of both originating and terminating application types, i.e. it is able to download and upload file.

In the case where the packet-switched network protocol is TCP/IP and UDP, the port number field relates to the application type.

Associated with the legitimate address table database 18, an Internet program is validated for its application type and legitimate direction, e.g. a program of originating access type that sends message to a legitimate destination address, of a destination node, and source address (its internal IP address) that had been registered in the legitimate application table.

The database building unit 14 is connected to the incoming control unit 10 and to the outgoing control unit 12 in order to validate an incoming or an outgoing data packet.

Still referring to FIG. 2, the outgoing control unit 12 intercepts an outgoing data packet from a network application 24 and provides the address, information extracted from the data packet including the data packet port number and packet direction to the database building unit 14 for validation of its legitimacy.

Still referring to FIG. 2, the incoming control unit 10 intercepts an incoming data packet from an external application and provides the address, data packet message information including port number, and packet direction to the database building unit 14. The database building unit 14 provides data packet message information to the application type table database 16, to the legitimate address table database 18 and to the fraudulent access table database 20 for validation of its legitimacy.

In the case where the incoming data packet is required to be validated against the legitimate address table (LAT) database 18, the source address of the incoming data packet has to be registered in the legitimate address table (LAT) database 18, with correct direction. If this is not the case, the incoming data packet is considered illegitimate.

The incoming control unit 10 intercepts an incoming data packet from a host of the network 8 and provides the address, information extracted from the data packet including the data packet port number and packet direction to the database building unit 14 for validation of its legitimacy.

In the case of a validation of an incoming data packet, the database building unit 14 provides a positive validation signal to the incoming control unit 10 if the validation of the incoming data packet is successful. The database building unit 14 provides a negative validation signal to the incoming control unit 10, if the validation of the incoming data packet fails. Upon receipt of the positive validation signal, the incoming control unit 10 provides the received data packet to the network application 24.

In the case of a validation of an outgoing data packet, the database building unit 14 provides a positive validation signal to the outgoing control unit 12 if the validation of the outgoing data packet is successful. The database building unit 14 provides a negative validation signal to the outgoing control unit 12 if the validation of the outgoing data packet fails. Upon receipt of the positive validation signal, the outgoing control unit 12 will provide the received data packet to the network 8.

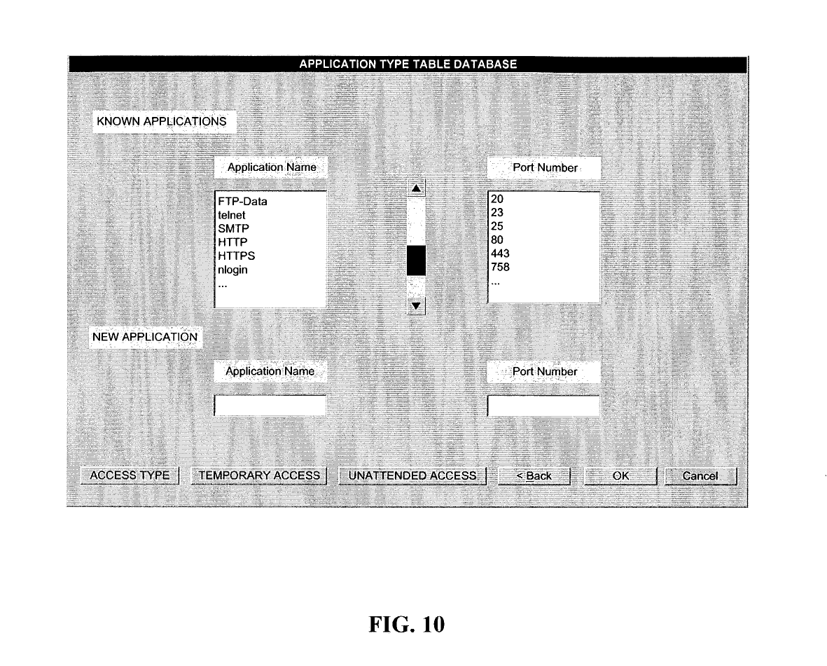

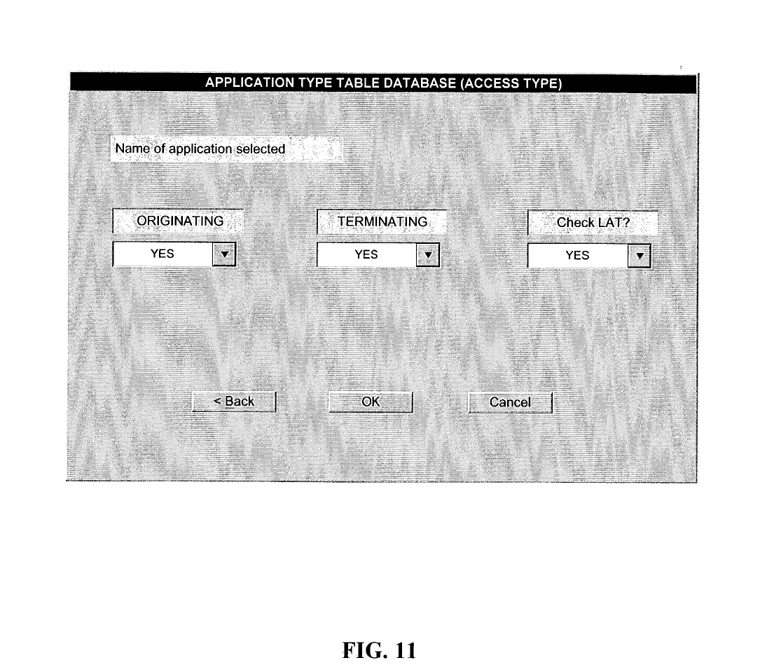

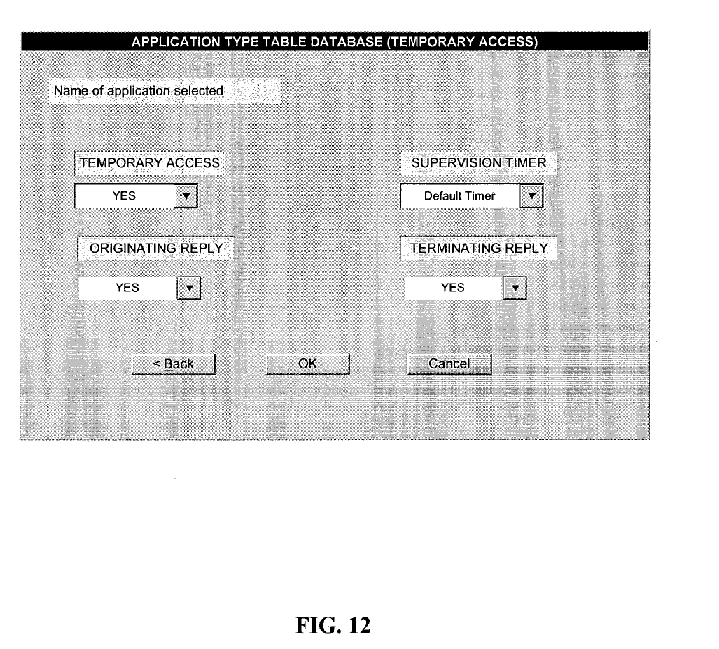

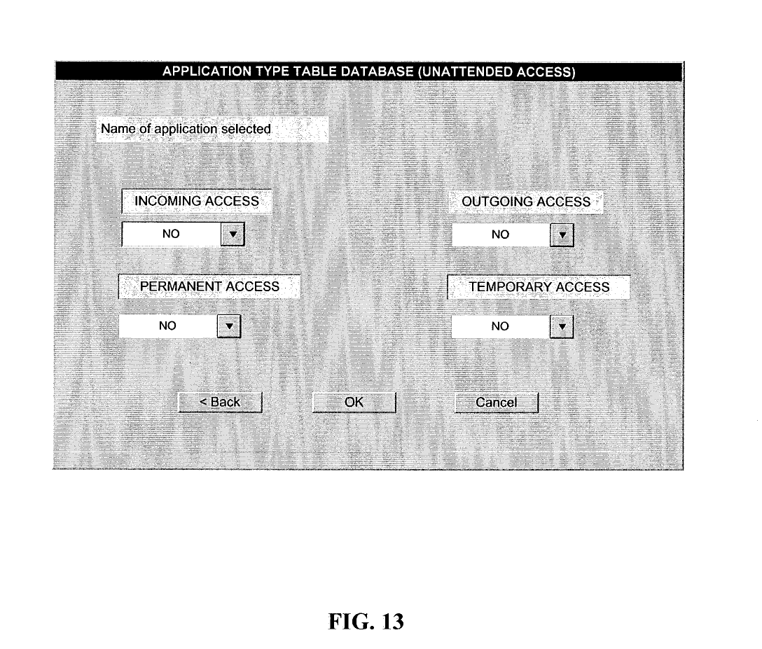

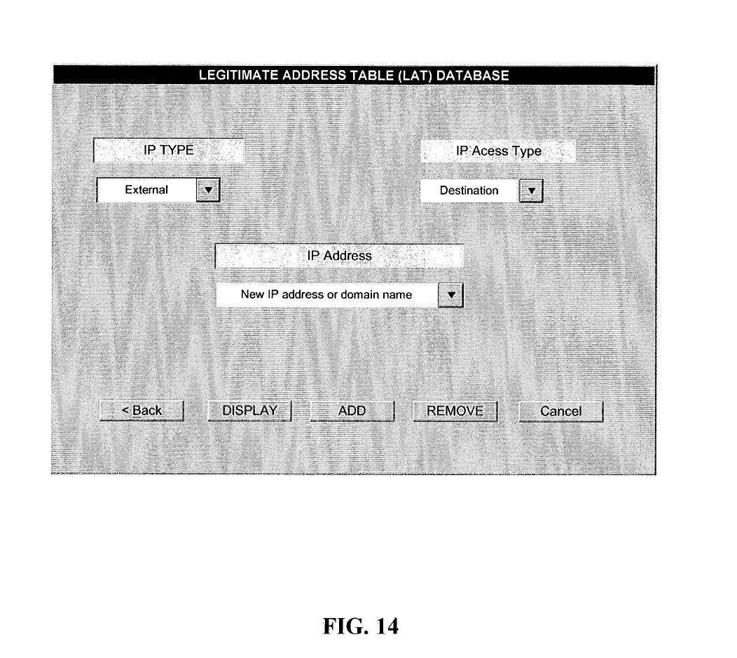

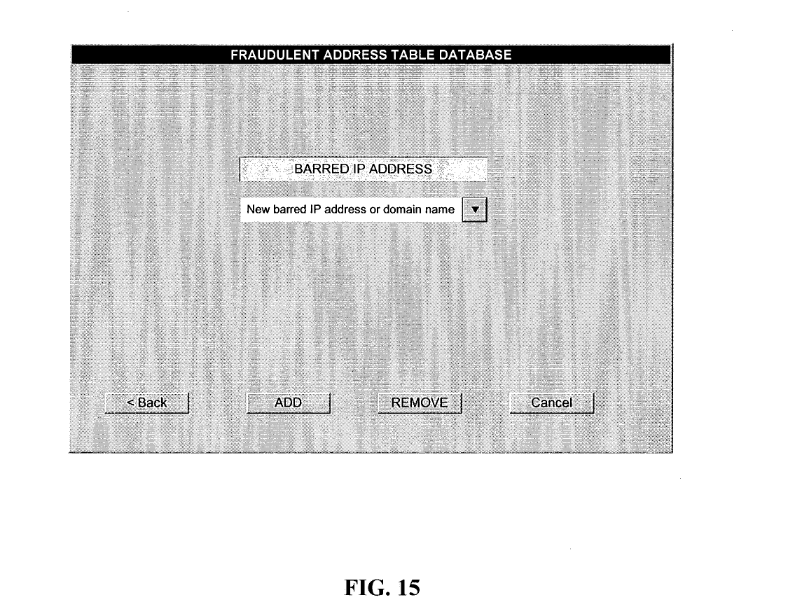

The database building unit 14 further provides, in the preferred embodiment of the invention, a graphics user interface (GUI), as shown in FIG. 10-15 for a database access. Preferably, the graphics user interface comprises 6 screens, with recommended values, for enabling a user to enter required data for validation of a network application 24. Each application type has default values set.

The database building unit 14 enables a system user or a system administrator to enter or edit data in any one of the application type table database 16, the legitimate address table database 18 and the fraudulent address table database 20.

The database building unit 14 operates using the application type table (ATT) database 16, the legitimate address table (LAT) database 18 and the fraudulent address table (FAT) database 20 in order to determine whether a received data packet is fraudulent or not, based on its application type, source address, and destination address. The user or the system administrator is preferable able to define, using the database building unit 14, actions to be taken in the case where a fraudulent activity is detected. Alternatively, various configurations of actions to take upon detection of a fraudulent activity are already implemented.

It will be appreciated that in order to facilitate administering tasks, a Domain name server (DNS) may be used in order to translate an IP address into its domain name.

If the monitoring system is implemented on a stand-alone computer connected to the Internet, the internal IP address is the Internet Protocol (IP) address of the computer, and the validation against its address in not necessary. The validation of internal addresses is preferably required if the monitoring system is implemented on a network gateway.

The alarm and report system unit 22 enables the system user or the administrator to select a type of data to log. The request for selected data is provided to the database building unit 14 in the preferred embodiment of the invention. In the preferred embodiment, data to output is provided by the alarm and report system to an output unit 30.

The alarm and report system unit 22 further implements reports and alert schemes. For instance, in one embodiment, a logged suspect activity may be printed on a designated printer. In another embodiment, suspect data may be displayed on a console. Alternatively, various types of output unit 30 may be implemented such as a speaker, generated sound, a voice message, a Short Message Service (SMS) notification mechanism for sending a SMS to the user or to the administrator, etc.

The alarm and report system unit 22 further enables the system user or the administrator to have access to selected activity on the output unit 30, which is, in this embodiment, a console. For instance, all outgoing packets with destination address or domain name may be displayed on the console.

The alarm and report system unit 22 may further log all data packets going through the incoming control unit 10, the outgoing control unit 12, or only suspect packets. Preferably, fraudulent data packets are logged.

Preferably, a log file parser and analyzer are provided in order to analyze log files created by the alarm and report system unit 22. Such log file parser and analyzer reassemble data packets into meaningful information such as filename and content.

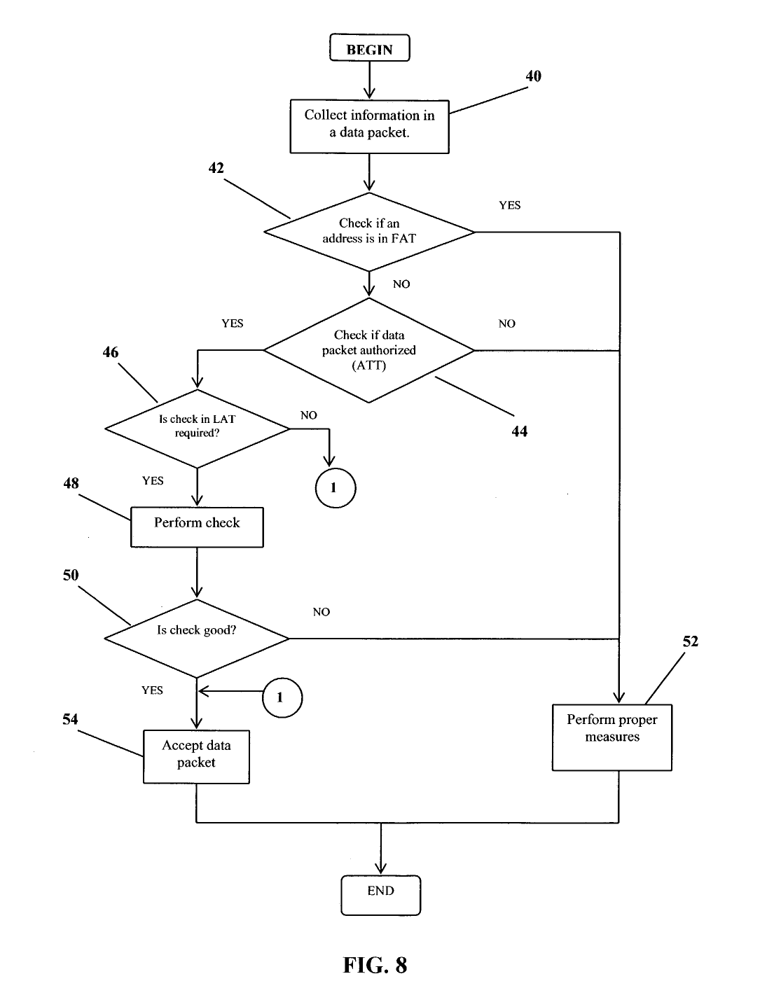

Now referring to FIG. 8, there is shown the preferred embodiment of the invention.

According to step 40, pertinent information is collected from a data packet using either the incoming control unit 10 or using the outgoing control unit 12. The pertinent information is provided to the database building unit 14.

According to step 42, the database building unit 14 checks if the IP address of the data packet is registered in the fraudulent address table database 20. If this is the case and according to step 52, proper measures are enforced. The proper measures depend on the setting as explained below, but for instance, subsequent data packets can be stopped or filtered out.

If the IP address of the data packet is not located in the fraudulent address table database 20 and according to step 44, a check is performed by the database building unit 14 using at least one part of the pertinent information and the application type table database 16. If the data packet is does not satisfy criteria located in the application type table database 16 and according to step 52, proper measures are enforced.

If the data packet complies with criteria located in the application type table database 16 and according to step 46, a check is performed by the database building unit 14 in order to find out if an access to the legitimate address table (LAT) database 18 is required.

If no access to the legitimate address table (LAT) database 18 is required and in accordance with step 54, the data packet is accepted and a positive validation signal is sent either to the incoming control unit 10 or to the outgoing control unit 12.

If an access to the legitimate address table (LAT) database 18 is required and in accordance with step 48, a check is performed in the legitimate address table (LAT) database 18 by the database building unit 14 to find out if the address is located inside. A temporary address scheme may be allowed as explained below. If the check is successful, and in accordance with step 54, the data packet is accepted and a positive validation signal is sent either to the incoming control unit 10 or to the outgoing control unit 12. If the check is not successful and in accordance with step 52, proper measures are enforced.

An illegitimate outgoing data packet and its subsequent outgoing data packets are filtered out, stopped based on the action code defined by the system owner through the database building unit 14 during system set-up as explained below. The internal application that had originated the invalid outgoing message may be suspended or killed. Alternatively, the network connection may be shutdown, if this required by the user or the system administrator.

An illegitimate incoming data packet and subsequent incoming data packets are filtered out, stopped based on the action code defined by the user or the system administrator through the database building unit 14 during system set-up. As explained above, the network application 24 that may have received the invalid incoming data packet may be suspended or killed. The network connection may also be shut down if required by owner for invalid access.

Preferably, the user or the system administrator is able to define various operating configurations using the database building unit 14.

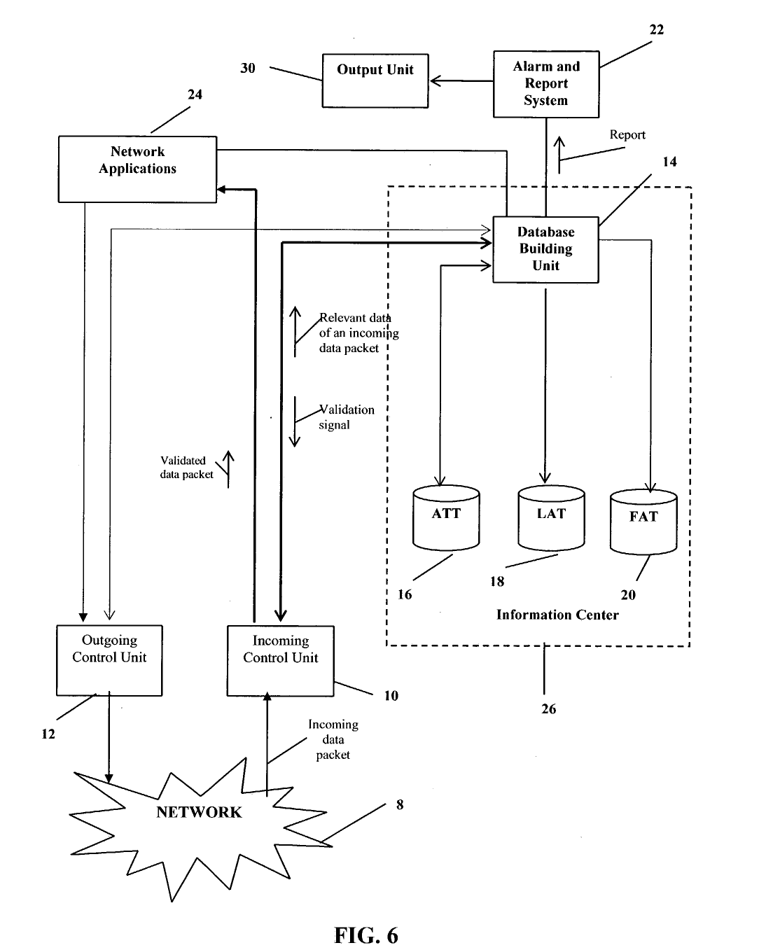

For instance, in a first operating configuration, the monitoring system is set to listen, intercept and validate any incoming data packet as shown in FIG. 6.

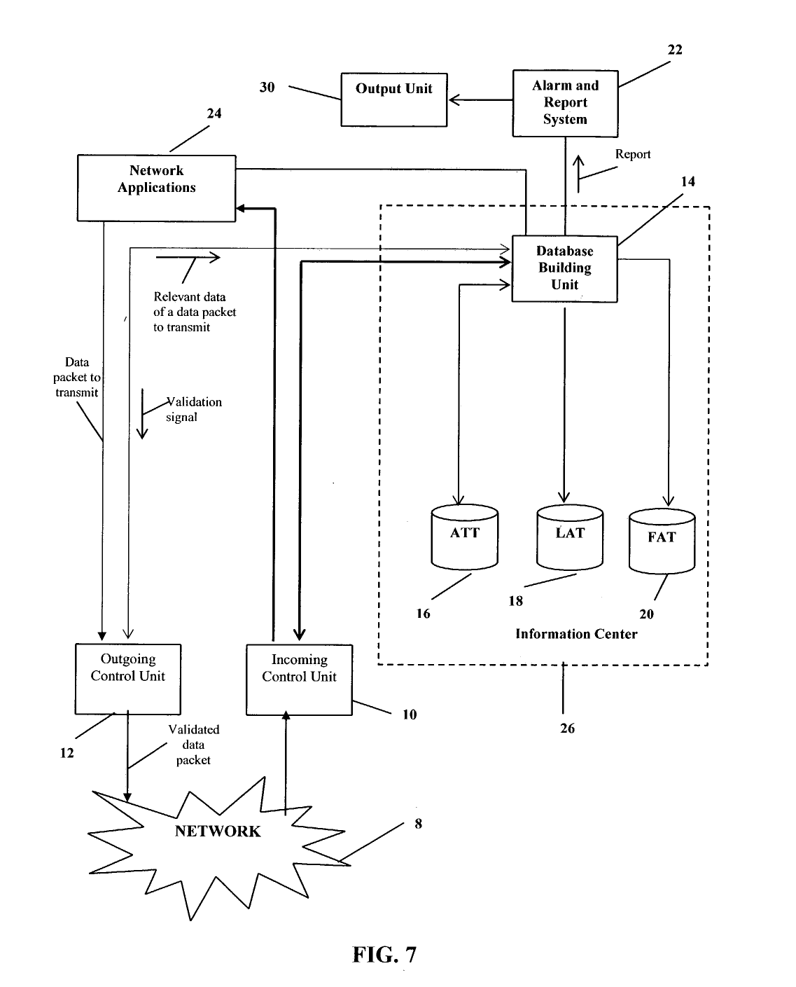

In a second operating configuration, the monitoring system is set to listen to, to intercept and to validate any data packet to transmit on the network as shown in FIG. 7.

In a third operating configuration, the monitoring system is set to suspend or kill any internal application 24 responsible of sending or receiving a detected illegitimate data packet.

In a fourth operating configuration, the monitoring system is set to shutdown the network connection in the case where an illegal activity is detected. With such operating configuration, the computer is easily isolated from a hacking attempt originating from the network 8. This is preferably performed by sending a negative decision signal, comprising a shutdown action code, to the incoming control unit 10 and to the outgoing control unit 12. Upon reception of the negative decision signal, comprising a shutdown action code, the incoming control unit 10 and the outgoing control unit 12 will terminate the access to the network. Alternatively, the connection to the network 8 is terminated using known operating systems as known by someone skilled in the art.

In a fifth operating configuration, the monitoring system is set to filter out any illegitimate packets. In such case, incoming data packets as well as outgoing data packets are filtered. Fraudulent data packets are discarded.

Operating without a Validation

In such embodiment, the database building unit 14 monitors the network 8 connection using the incoming control unit 10. The incoming control unit 10 provides data related to each incoming data packet to the database building unit 14 but it will be appreciated that in such operating mode, no validation is performed.

A report signal is preferably sent by the alarm and report system 22. The report is outputted on the output unit 30 and comprises a display of the incoming data traffic.

Upon reception of the report and according to its content, the user or the system administrator may amend the application type table database.

Such embodiment enables data monitoring.

Operating with a Partial Validation

In another embodiment of the invention, each data packet received by the incoming control unit 10 is validated against the application type table (ATT) database 16 and the fraudulent address table (FAT) database 20. As explained previously, the fraudulent address table (FAT) database 20 comprises barred addresses.

If the address of an incoming data packet is located in the fraudulent address table (FAT) database 20, the incoming data packet and subsequent incoming data packets of the same message are considered to be illegitimate. If this is not the case, the incoming data packet is considered to be legitimate. In the case where illegitimate incoming data packets are found, a report is generated to the alarm and report system 22 by the database building unit 14. Relevant data is then preferably logged. The user or the system administrator operating the monitoring system is then being informed of such fraudulent activity using the output unit 30.

Alternatively, a filtering scheme is performed on the incoming data packets originating from or going to the fraudulent address. Such IP filtering may be provided by the Internet application provider, by the operating system or by the drivers of the Network card or dialup modem.

The user or the system administrator is able preferably to administer the barred addressees in the fraudulent address table (FAT) database 20.

Operating with a Validation Against the Legitimate Address Table, to the Fraudulent Address Table and the Application Type Table

Incoming Data Packet

Now referring to FIG. 6, there is shown another alternative embodiment where a validation against the legitimate address table, the fraudulent access table and the application type table is performed for an incoming data packet.

According to a first step, the incoming control unit 10 receives an incoming data packet from the network 8 via a network card for instance.

According to a second step, relevant data of the incoming data packet is sent to the database building unit 14. In the preferred embodiment of the invention, the relevant information of the incoming data packet comprises required data including source address, destination address, port numbers, and sequence number.

According to a third step, a validation is performed by the database building unit 14 using the application type table database 16, the legitimate address table database 18 and the fraudulent address table database 20.

Preferably, if the address of the incoming data packet is located in the fraudulent address table database 20, the incoming data packet and subsequent incoming data packets are considered to be illegitimate packets. In such case, a negative decision signal is provided to the incoming control unit 10. The negative decision signal comprises an action signal. The action signal refers to actions that have to be taken in response to the detection by the incoming control unit 10.

If the address of the incoming data packet is not located in the fraudulent address table database 20, the application type of the incoming data packet is checked against the application type table database 16.

Someone skilled in the art will appreciate that many applications have an application type identification that enables it to send/receive data packets over a packet switched network.

If an application type is allowed to receive a data packet from the Internet, the receiving source address of the incoming data packet will be checked against legitimate address table database 18. If the incoming data packet address is located in the legitimate address table database 18 with a pre-defined direction, the incoming data packet is considered to be a legitimate data packet. In such a case, a positive decision signal is provided to the incoming control unit 10. If this is not the case, a negative decision signal is provided to the incoming control unit 10. The negative decision signal comprises an action signal. The action signal refers to actions that have to be taken in response to the detection.

As explained above, and in the case where the data packet is found to be a fraudulent data packet, an action code is provided.

In the preferred embodiment of the invention, the action code refers to any one of performing a disconnection of the Internet connection, suspending or killing the suspect internal application that may have received the data packet and filtering out the fraudulent data packet and its subsequent data packets.

Still referring to this embodiment, and according to a fifth step, a report signal is provided by the database building unit 14 to the alarm and report system 22.

Outgoing Data Packet

Now referring to FIG. 7, there is shown an alternative embodiment where a validation against the legitimate address table, the fraudulent address table and the application type table is performed for an outgoing data packet.

According to a first step the outgoing control unit 12 collects an outgoing data packet generated by a network application 24.

According to a second step, relevant data of the outgoing data packet is provided by the outgoing control unit 12 to the database building unit 14. In the preferred embodiment of the invention, the relevant data signal comprises required data including destination address, source address, port numbers, and sequence number.

According to a third step, a validation is performed by the database building unit 14 using the application type table database 16, the legitimate address table database 18 and the fraudulent address table database 20.

Preferably, if the address of the outgoing data packet is located in the fraudulent address table database 20, the outgoing data packet and subsequent outgoing data packets are considered to be illegitimate packets. In such case, a negative decision signal is provided by the database building unit to the outgoing control unit 12. The negative decision signal comprises an action signal. The action signal refers to actions that have to be taken in response to the detection.

If the address of the outgoing data packet is not located in the fraudulent address table database 20, the application type of the data packet is checked against the application type table database 16.

If an application type is allowed to send a data packet to the Internet, the destination address of the received data packet will be checked against the legitimate address table database 18. If the destination data packet address is located in the legitimate address table database 18 with a pre-defined direction, the data packet is considered to be a legitimate data packet. In such a case, an approval signal is provided to the outgoing control unit 12. If this is not the case, an error signal is provided to the outgoing control unit 12. The error signal comprises an action signal. The action signal refers to actions that have to be taken in response to the detection.

As explained above, and in the case where the outgoing data packet is found to be a fraudulent data packet, an action code is provided.

In the preferred embodiment of the invention, the action code refers to any one of performing a disconnection of the Internet connection, suspending or killing a suspect internal application that has provided the outgoing data packet and filtering out the fraudulent outgoing data packet and its subsequent data packets.

Still referring to FIG. 7, and according to a fifth step, a report signal is provided by the database building unit 14 to the alarm and report system 22. As explained previously, the alarm and report system 22 reports to a user or a system administrator any fraudulent activity. As explained previously, the report to the user or the system administrator is done by displaying fraudulent data on a console or alerting the person using SMS.

The user or the system administrator is able to amend the fraudulent address table database 20. Alternatively, the fraudulent address table database 20 is amended in accordance with predetermined rules.

Unattended Monitoring Mode

Preferably, a user away from his computer sets his computer to unattended monitoring mode. Upon activation, the system will allow only access to ongoing legitimate internet activity such as email such as a file transfer protocol.

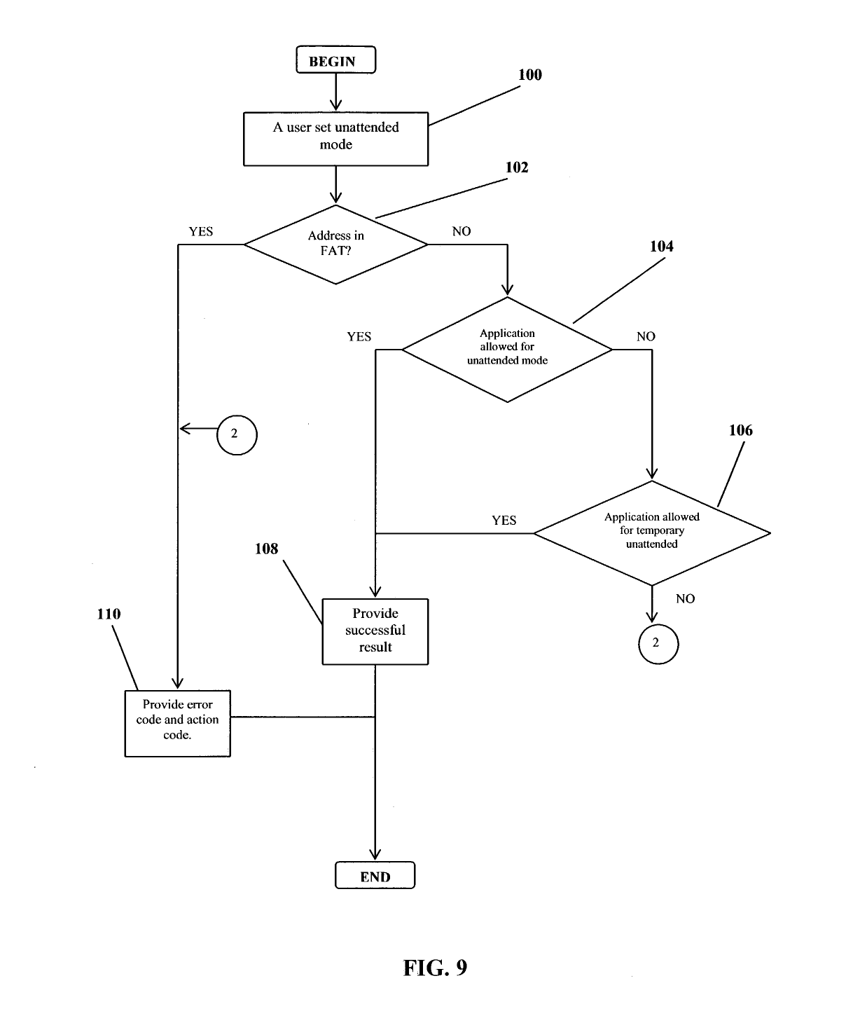

Now referring to FIG. 9, there is shown how the unattended monitoring mode operates.

According to step 100, the computer is set in “unattended mode”. Such setting is either performed by the user or by a detection algorithm. The detection algorithm checks, in one embodiment, if the user has provided an input to the computer in a predetermined amount of time. The detection algorithm checks also for instance if a screen saver is launched.

Still referring to FIG. 9 and according to step 102, a check is performed on an originating data packet address in the case where an incoming data packet is collected by the incoming control unit to find out if the originating data packet address is located in the fraudulent address table database 20.

Similarly, in the case of an outgoing data packet, collected by the outgoing control unit 12, a check is performed in order to find out if the destination address is located in the fraudulent address table database 20.

If an entry is found in the fraudulent address table database 20, a negative decision signal is provided either to the incoming control unit 10, in the case of an incoming data packet or to the outgoing control unit 12, in the case of an outgoing data packet.

In the case where the destination address or the originating data packet address is not located in the fraudulent address table database 20, and according to step 104, a check is performed in order to find out if the application related to the incoming data packet or the outgoing data packet allows unattended mode. Such step is performed by accessing the application type table database 16.

If this is the case and according to step 108, a positive decision signal is provided. In the case of an incoming data packet, the positive decision signal is provided to the incoming control unit 10. Similarly, in the case of an outgoing data packet, the positive decision signal is sent to the outgoing control unit 12.

In the case where an application does not allow permanently unattended mode and according to step 106, a check is performed to find out if temporary unattended mode is allowed. Such check is performed using the application type table database 16. If this is the case and according to step 108, a positive decision signal is provided. If this is not the case and according to step 110, a negative decision signal is provided.

Now referring back to FIG. 5, it will be appreciated that an application may be allowed to receive but not to transmit data packet for instance. Someone skilled in the art will appreciate that such flexibility is of great advantage.

Temporary Address Management

Preferably, a temporary address management is implemented. A temporary address may be either a destination address for an outgoing data packet or an originating address for an incoming data packet.

In order to enhance security, a temporary address of a replied message is also created in the legitimate address table 18; the temporary address is time supervised. For instance, the user or the system administrator allows download activity of a Peer-to-Peer (p2p) application, but not upload activity by using the application type table database 16. The monitored host provides an outgoing message, p2p download, for which the destination address of an external node is inserted in the legitimate address table database 18 as destination and source temporary addresses.

The time-supervised temporary source address is used in order to validate the replied incoming data packets from an external node.

A temporary address is preferably set for a predetermined amount of time in the legitimate address table database 18 and is removed from said table after said amount of time elapsed.

Outgoing Data Packet

In the case where an outgoing data packet is generated by a network application 24 and has to be sent to a destination address, the network application registers the destination address, in the case where this is possible, in the legitimate address table database 18. It will be appreciated that no registration of a temporary address occurs if the address is already located in the legitimate address table database 18 or in the fraudulent address table database 20.

Preferably, a timer is started at the time of registration. In one embodiment, a predetermined amount of time is fixed, in another alternative embodiment, the amount of time is randomly set.

After registration, each packet to be transmitted is checked as explained in the embodiment described above.

Preferably, in the case of a detection of fraudulent activity, at least one temporary address may be removed from the legitimate address table database 18, in order to strengthen the security of the system. Furthermore the address which is considered to be an illegitimate address may be added to the fraudulent address table.

Incoming Data Packet

In the case of an incoming data packet, temporary addresses are also used and stored in legitimate address table database 18.

At a certain time, the amount of time set for a temporary address expires, which causes the temporary address to be removed from the legitimate address table database 18. Future data packets originating from this temporary address will be declared invalid unless they are re-registered by the application. The network application will at this point perform a request for adding a temporary address in the legitimate address table database 18. Preferably, the value of the supervision timer is updated in the application type table database 16 automatically by the monitoring system. The user can manually change the value of a supervision timer via the graphics user interface of the database building unit 14.

In the case where a data packet originates from the network, the address of the data packet has to be registered in the legitimate address table database 18. This is possible if the data packet is used by an application for which is it possible to receive a data packet having a temporary address registered in the legitimate address table database 18. This is known by accessing the application type table database 16. Preferably a timer is set for receiving other data packets from a message. Upon receiving of all data packets from the message, the temporary address is removed from the legitimate address table database 18.

It will be appreciated that no temporary address is created if the data packet address is located already in the fraudulent address table (FAT). It will be appreciated that such measure avoids a flooding of the system. It will further be appreciated that no temporary address is created if the data packet address has already an entry in the legitimate address table database 18 in a permanent.

In the case where a high level of security is required, any fraudulent data packet will be stopped entering and existing the monitored system if an illegitimate activity is detected.

Gateway Embodiment

It will be appreciated that the monitoring system disclosed may be used in a network comprising a plurality of computer.

In the case where the legitimate address table database 18 is located on a network gateway, all internal nodes will have preferably their IP addresses registered as legitimate source and destination addresses.

However, it will be appreciated that a system administrator can restrict the Internet access to some internal nodes for security reasons. In such case, the administrator provides the addresses of those nodes in the fraudulent address table database 18. The system administrator can further prohibit access of some application types on certain nodes.

It will be appreciated that this provides a flexible way to manage the sharing of data information in a network.

The embodiments of the invention described above are intended to be exemplary only. The scope of the invention is therefore intended to be limited solely by the scope of the appended claims.

I claim:

1. A method for filtering a data packet shared between a first network host and a second network host connected using a packet-switched network connection, comprising:
receiving a data packet originating from a network application running on a first network host, the data packet comprising at least a network application type identifier and an address on said packet-switched network;
performing a first check to find out if said address is acceptable using a fraudulent address table database and a legitimate address table database;
performing a second check using at least said network application type identifier and an application type table database comprising at least a list of a plurality of allowed network applications;
providing said data packet to a second network host if said first check and said second check are successful.

2. The method as claimed in claim 1, further comprising temporarily inserting the address in the legitimate address table database, for a predetermined amount of time, if said address is not in the fraudulent address table database.

3. The method as claimed in claim 2, wherein the predetermined amount of time is randomly set.

4. The method as claimed in claim 1, wherein the address of the data packet is inserted in the fraudulent address table database if said data packet is not provided to said second network host.

5. The method as claimed in claim 1, further comprising the step of generating a report using an alarm and report unit to a user, the report comprising at least one part of said data packet.

6. The method as claimed in claim 5, wherein the generating of a report comprises the sending of a message to said user using a Short Message Service (SMS).

7. The method as claimed in claim 5, wherein the generating of a report comprises the displaying of at least one part of the data packet on a console.

8. The method as claimed in claim 1, further comprising the removing of the packet-switched network connection between said first host and said second host if said data packet is not provided to said second network host.

9. The method as claimed in claim 1, wherein a controllable network application is generating the data packet, further comprising the ending of the controllable network application if said data packet is not provided to said second network host.

10. The method as claimed in claim 1, wherein the data packet is an outgoing data packet, further wherein the address on the network is a destination address for said data packet.

11. The method as claimed in claim 1, wherein the data packet is an incoming data packet; further wherein the address on the network is a source address of said data packet.

12. The method as claimed in claim 11, wherein said second network host is operated under a supervision of a user.

13. The method as claimed in claim 12, further comprising detecting if said user is located in the vicinity of said second network host, further comprising the step of amending at least the application type table database if said user is not in the vicinity of said second network host.

14. The method as claimed in claim 1, wherein the data packet originates from a network host of a plurality of network hosts located on a first packet-switched network connected to another packet switched network comprising said second network host.

15. The method as claimed in claim 1, wherein a message, shared between a first network host and a second network host, comprises a plurality of data packets, further wherein said first check and said second check are performed on a selected data packet of said message, further wherein the providing of said message to a second network host is performed if said first check and said second check on said selected data packet are successful.

16. The method as claimed in claim 15, wherein the selected data packet is the first data packet of said message.

17. The method as claimed in claim 1, further comprising the step of amending the application type table database.

18. An apparatus for filtering a data packet shared between a first network host and a second network host connected using a packet-switched network, comprising:
a fraudulent address table database, comprising a plurality of illegitimate addresses;
an application type table database comprising at least a list of allowed network applications;
a legitimate address table database comprising at least a list of allowed addresses;
a control unit intercepting a data packet originating from a network application running on a first network host and providing at least a network application type identifier and an address and further providing said data packet to a second network host upon reception of a positive decision signal;
a database building unit receiving at least said network application type identifier and said address, checking at least said provided network application type identifier and said address using said fraudulent address table database, said application type table database and said legitimate address table database, and providing said positive decision signal to said control unit if said checking is successful.

19. The apparatus as claimed in claim 18, wherein the application type table database comprises for each of said allowed network applications an identifier identifying if the network application is allowed when a user is not in the vicinity of said first network host.

20. The apparatus as claimed in claim 18, wherein a negative decision signal is provided by the database building unit to the control unit if said checking is not successful; further comprising an alarm and report unit connected to said database building unit and providing a report to a user if a negative decision signal is provided to said control unit.

21. The apparatus as claimed in claim 18, wherein the control unit is an incoming control unit receiving an incoming data packet; further wherein the address is a source address of said data packet.

22. The apparatus as claimed in claim 18, wherein the control unit is an outgoing control unit receiving an outgoing data packet; further wherein the address is a destination address of said data packet.

23. A method for monitoring a data packet shared between a first network host and a second network host connected using a packet-switched network connection, comprising:
receiving a data packet originating from a network application running on a first network host, the data packet comprising at least a network application type identifier and an address on said packet-switched network;
performing a first check to find out if said address for a second network host is acceptable using a fraudulent address table database and a legitimate address table database;
performing a second check using at least said network application type identifier and an application type table database comprising at least a list of a plurality of allowed network applications;
providing a report, comprising at least one part of said data packet, to a user if said first check and said second check are not successful; and
providing said data packet to said second network host.

24. The method as claimed in claim 23, wherein said report is provided to said user using a Short Message Service (SMS).

25. The method as claimed in claim 23, wherein the data packet is an incoming data packet; further wherein the address is a source address of said data packet.

26. The method as claimed in claim 23, wherein the data packet is an outgoing data packet; further wherein the address is a destination address of said data packet.

27. The method as claimed in claim 23, wherein said report is provided to said user through a console.

28. The method as claimed in claim 23, further comprising the step of amending the application type table database after the reception of said report by said user.

29. The method as claimed in claim 1, wherein the data packet comprises more than one address.

30. The method as claimed in claim 11, wherein a controllable network application is receiving the incoming data packet, further comprising the ending of the controllable network application if said data packet is not provided to said second network host.
